(19) United States
(12) Patent Application Publication
(10) Pub. No.: US 2016/0350712 A1
(43) Pub. Date: Dec. 1, 2016

(54) PROVIDING SHIPPING SERVICES TO SHIPPERS

(71) Applicant: KOLOBIT, LLC, North Salt Lake, UT (US)

(72) Inventors: Darren L. WESEMANN, North Salt Lake, UT (US); Kyle R. HUNT, Riverton, UT (US)

(21) Appl. No.: 14/726,298

(22) Filed: May 29, 2015

(51) Int. Cl. G06Q 10/08

(52) U.S. Cl. CPC G06Q 10/0834; G06Q 10/0833

(57) ABSTRACT

A method for providing shipping services to shippers, by which packages associated with the shippers are shipped by a shipping carrier, the method being performed by a system associated with a shipping intermediary, may include establishing a communication interface with the shipping carrier. The method may include receiving a shipping intermediary identifier from the shipping carrier. The method may include in response to a request from a first shipper for the shipping services, transmitting to the first shipper information allowing the first shipper to obtain a first shipping label associated with the shipping intermediary identifier. The method may include in response to a request from a second shipper for the shipping services, transmitting to the second shipper information allowing the second shipper to obtain a second shipping label associated with the shipping intermediary identifier.

### FIELD

The implementations discussed in the present disclosure are related to providing shipping services to shippers.

### BACKGROUND

Individuals, organizations, and business entities may utilize one or more shipping carriers to ship packages on a regular basis. The shipping carriers may include, for example, the United Parcel Service (UPSTM), FedEx®, the United States Postal Server (USPS), DHL Express, or various other shipping carriers. Each of the shipping carriers may provide one or more shipping programs, which may be designed to provide one or more shipping services to shippers.

The subject matter claimed in the present disclosure is not limited to implementations that solve any disadvantages or that operate only in environments such as those described above. Rather, this background is only provided to illustrate one example technology area where some implementations described may be practiced. Furthermore, unless otherwise indicated, the materials described in the background section are not prior art to the claims in the present application and are not admitted to be prior art by inclusion in this section.

### SUMMARY

According to an aspect of an implementation, a method for providing shipping services to shippers, by which packages associated with the shippers are shipped by a shipping carrier, the method being performed by a system associated with a shipping intermediary, may include establishing a communication interface with the shipping carrier. The method may also include receiving a shipping intermediary identifier from the shipping carrier, the shipping intermediary identifier being used by the shipping carrier to provide the shipping services for packages that bear the shipping intermediary identifier. The method may further include in response to a request from a first shipper for the shipping services, transmitting to the first shipper information allowing the first shipper to obtain a first shipping label associated with the shipping intermediary identifier. Additionally, the method may include in response to a request from a second shipper for the shipping services, transmitting to the second shipper information allowing the second shipper to obtain a second shipping label associated with the shipping intermediary identifier, such that, when the first shipper and the second shipper use the shipping services, the shipping carrier does not distinguish the identities of the first shipper and the second shipper.

The object and advantages of the implementations will be realized and achieved at least by the elements, features, and combinations particularly pointed out in the claims.

It is to be understood that both the foregoing general description and the following detailed description are given as examples and explanatory and are not restrictive of the invention, as claimed.

### BRIEF DESCRIPTION OF THE DRAWINGS

Example implementations will be described and explained with additional specificity and detail through the use of the accompanying drawings in which:

FIG. 1 is a block diagram of an example environment related to providing shipping services to shippers;

FIG. 2 is a block diagram of an example computing system that may be included in the environment of FIG. 1; and

FIG. 3 is a flow diagram of an example method to provide shipping services to shippers.

### DESCRIPTION OF IMPLEMENTATIONS

Historically, postage stamps have been applied to packages as a representation to the USPS that a required fee for delivering a package has been paid. An improvement to utilization of physical postage stamps is the application of indicia of postage with a postage meter, which may be physical or virtual. The USPS now authorizes a shipper to use PC Postage™, which may allow the shipper to purchase postage via an online postage vendor, such as, for example, Endicia™ or Stamps.com™, and apply the indicia of postage to a package to be shipped. Using PC Postage, a shipping label that includes the indicia of postage may be printed on a standard printer coupled to, for example, the shipper's personal computer.

In recent years, the USPS has also implemented the Electronic Verification System (eVS®) of the United States Postal Service (USPS), which is designed for high-volume shippers to conduct their business with the USPS using electronic technology. For example, eVS may include a manifesting system that allows shippers to document and pay postage by transmitting electronic manifest files to eVS. Using eVS, high-volume shippers may prepare package shipments, submit electronic documentation, and streamline their internal business processes and interactions with the USPS.

In the present disclosure, the term “shipper” may refer to any entity that ships packages from one location to another using a carrier. For example, a shipper may include one or more of the following: individuals, organizations, government entities, and businesses. Embodiments are also described herein in the context of shipping “packages.” As used herein, the term “packages,” unless otherwise specified, extends to substantially any item that can be shipped by a shipping carrier, including boxes, bulk goods, letters, envelopes, etc. Packages are not limited to any sort of size, containers, contents, etc. The term “shipping label,” unless otherwise specified, extends to any physical article or printed material that includes the information described herein for enabling a shipping carrier to accept a package for shipping services. The shipping label may include a number, text, a barcode or other information that achieves this purpose. Unless otherwise specified, the physical details of the shipping label are not critical, and the embodiments described herein can be adapted for us with shipping services that might use any type of shipping label.

In some instances, the shipper may engage in a number of actions in order to receive one or more shipping services provided by a shipping carrier system through a shipping program, which may include a program or group of programs designed for an end user, such as, for example, the shipper. As used herein, the term “shipping program” extends to shipping services that are offered by a shipping carrier, along with corresponding schedules of shipping rates, systems for tracking shipped goods, systems for receiving payment and providing shipping labels, pickup and delivery services, and related communication systems (e.g., Internet and e-commerce systems). Embodiments are described herein primarily on the context of eVS, which is an example of a shipping program that is suitable for use with such embodiments. The principles described herein, however, can be adapted for use with other shipping programs, including those that are offered by the USPS or other shipping carriers, and further including shipping programs that might be offered in the future.

Shippers have conventionally used the shipping program eVS, by registering for eVS participation. Registration may include creating a user account, establishing an eVS profile, and entering various types of information, such as a corporate site address, banking information, etc. The shipper may also apply for a permit imprint account, which may be linked to a Centralized Account Processing System (CAPS) debit account for automatic withdrawal of funds each time a postage statement is generated by eVS. Additionally, the shipper may obtain a master Mailer Identification (MID) number. The master MID number may identify the shipper in eVS. Additional MIDs may be obtained by the shipper if, for example, the shipper has multiple shipping sites. The shipper may also pay various annual fees to the USPS to use eVS. Further, the shipper may submit an eVS manifest application, which may solicit information for determining a projected level of postal resources that may be used to help the shipper meet eVS requirements for manifesting.

In order to receive the shipping services provided through eVS, another hurdle the shipper may face includes developing or obtaining software to interface with eVS. For example, the shipper may develop or obtain the software that meets eVS electronic file and barcode specifications for producing accurate eVS manifests and barcodes. Developing the software or obtaining the software from a vendor may be expensive and may be followed by testing. For example, the software may be evaluated by the USPS to determine if the software is compliant with eVS, which may be time-consuming. Shippers attempting to use a non-USPS shipping carrier system and/or a shipping program other than eVS may encounter similar obstacles.

In some instances, the shipping program may not be designed for use by both low-volume and high-volume shippers. The low-volume shippers may include shippers who ship, for example, less than a threshold volume, such as, for example, one hundred (100) packages per week. The high-volume shippers may include shippers who ship more than the threshold volume, such as, for example, more than one hundred (100) packages per week. An example of a high-volume shipper may include Amazon, which may ship thousands of packages per day. The low-volume shippers in particular may be discouraged from using eVS because they may be small and may have limited resources or expertise, which may discourage the low-volume shippers from developing or obtaining the software that meets eVS specifications and engaging in what may be a lengthy eVS application process. Currently, in at least some instances, the low-volume shippers may not be permitted to participate in eVS due to various requirements related to eVS which may make it difficult for the low-volume shippers to use eVS. For example, establishing a communication interface with the shipping carrier system and obtaining shipping labels directly from the shipping carrier system may be difficult using eVS if the particular shipper has more than a threshold volume of periodic shipping activities. The threshold volume of periodic shipping activities may correspond to a threshold number of packages and/or a weight of packages shipped by the shipper during a duration of time.

Some implementations described in the present disclosure may be used to provide shipping services to shippers. The shipping services may be configured to facilitate shipment by a shipping carrier of one or more packages associated with the shippers. The shipping services may be provided by a shipping carrier system through a shipping program that permits the shippers to establish a communication interface and to obtain shipping labels directly from the shipping carrier system only if the shippers have more than a threshold volume of periodic shipping activities.

In these and other implementations, the shippers may include one or more low-volume and/or one or more high-volume shippers. In these and other implementations, a shipping intermediary system, which may be operated by or associated with a shipping intermediary, may provide the shipping services to the low-volume shippers and/or the high-volume shippers by establishing a communication interface with the shipping carrier system. In these and other implementations, the shipping intermediary system may establish the communication interface with the shipper carrier so that the shippers may use the shipping program without obtaining or developing new software. For example, the shipping intermediary system may include a processor or processors, which may be executed in the cloud and may establish the communication interface by implementing an application program interface (API) provided by the shipping program, such as, for example, the USPS eVS Label API, via a network. A shipper device may include a shipper module which may execute in a browser and may be communicatively coupled to the label module via the network. Implementation of the API of the shipping program by the shipping intermediary system may allow the shipping intermediary system to act as an intermediary between the shippers and the shipping program and provide the shipping services to the shippers through the shipping program. The shipping intermediary system may coordinate one or more payments of the shippers to the shipping carrier system, send shipping labels configured to be printed from the shipping carrier system to the shippers, and interact with the shipping carrier system on behalf of the shippers. By signing up for the shipping services provided by the shipping intermediary system, the shippers may obtain, via the shipping intermediary system, the shipping services associated with the shipping program, which may not otherwise be available to the shippers.

In some implementations, the shipping intermediary system may also provide the shipping services to the shippers by receiving a shipping intermediary identifier from the shipping carrier system, the shipping intermediary identifier being used by the shipping carrier to provide the shipping services for packages that bear the shipping intermediary identifier. The shipping intermediary identifier may be associated with the shipping intermediary by the shipping carrier system. In these and other implementations, in response to a request from a first shipper for the shipping services, the shipping intermediary system may transmit to the first shipper information allowing the first shipper to obtain a first shipping label associated with the shipping intermediary identifier. Further, in these and other implementations, in response to a request from a second shipper for the shipping services, the shipping intermediary system may transmit to the second shipper information allowing the second shipper to obtain a second shipping label associated with the shipping intermediary identifier, such that, when the first shipper and the second shipper use the shipping services, the shipping carrier system does not distinguish identities of the first shipper and the second shipper. However, a database of shipping activity of the first shipper and the second shipper may be maintained by the shipping intermediary system, and the database may be configured to facilitate tracking of the first shipper and the second shipper by the shipping intermediary system via one or more account numbers, which may be assigned to the first shipper and the second shipper and stored within the database. The first shipper and the second shipper may have less than a threshold volume of periodic shipping activities, and thus, without the shipping intermediary system, may not be permitted by the shipping program to establish the communication interface and to obtain shipping labels directly from the shipping carrier. In these and other implementations, the shipping intermediary system may be configured to enable the first shipper and the second shipper to obtain the first shipping label and the second shipping label, respectively, which may be generated by the shipping program.

Further, in these and other implementations, in response to a request from a third shipper for the shipping services, the shipping intermediary system may transmit to the third shipper information allowing the third shipper to obtain a third shipping label associated with the shipping intermediary identifier and may assign the third shipper a customer identifier that allows the shipping carrier to identify the third shipper when the third shipper uses the shipping services. In these and other implementations, the customer identifier may be unique to the third shipper and may be assigned only to the third shipper. The third shipper may have at least the threshold volume of periodic shipping activities. Thus, in some implementations described in the present disclosure, the shipping intermediary system may provide the shipping services to both the low-volume shippers and the high-volume shippers.

Implementations of the present invention will be explained with reference to the accompanying drawings.

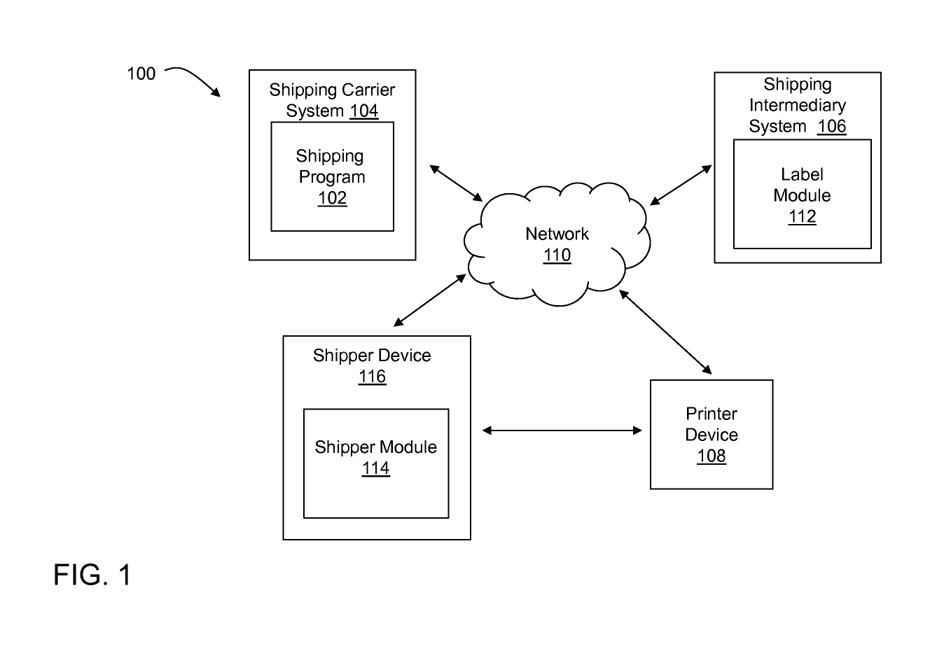

FIG. 1 is a block diagram of an example environment 100 related to facilitating use of a shipping program 102 by a shipper, arranged in accordance with at least one implementation described in the present disclosure. In some implementations, the environment 100 may include a shipping carrier system 104, a shipping intermediary system 106, a shipper device 116, a printer device 108, and a network 110. In the environment 100, the shipping carrier system 104 may include the shipping program 102. Also, in the environment 100, the shipping intermediary system 106 may include a label module 112. Further, in the environment 100, the shipper device 116 may include a shipper module 114. The shipping program 102, the label module 112, and the shipper module 114 may be configured to communicate and/or to exchange, via the network 110, information and data that may be used in one or more operations described in the present disclosure. The environment 100 may include other servers or devices not illustrated in FIG. 1.

In some implementations, the network 110 may include a wired or wireless network, and may include any suitable configuration, such as a star configuration, a token ring configuration, or other configurations. Furthermore, in some implementations, the network 110 may include an Ethernet network, a local area network (LAN), a wide area network (WAN) (e.g., the Internet), and/or other interconnected data paths across which multiple devices may communicate. In some implementations, the network 110 may include a peer-to-peer network. In some implementations, the network 110 may also be communicatively coupled to or include portions of a telecommunications network that may enable communication of data in a variety of different communication protocols.

In some implementations, the network 110 may include BLUETOOTH® communication networks and/or cellular communications networks for sending and receiving data including via short messaging service (SMS), multimedia messaging service (MMS), hypertext transfer protocol (HTTP), direct data connection, wireless application protocol (WAP), e-mail, etc. The network 110 may enable communication via a standard-based protocol such as smart energy profile (SEP), Echonet Lite, OpenADR, or another suitable protocol (e.g., wireless fidelity (Wi-Fi), ZigBee, HomePlug Green, etc.).

The shipping intermediary system 106 may include a hardware device such as a rack-mounted server, a blade server, or other hardware device that includes a processor, a memory, and network communication capabilities. In some implementations, the shipping intermediary system 106 may be communicatively coupled to the network 110. In some implementations, the label module 112 may send and receive data to and from the shipping carrier system 104 and/or the shipping program 102 via the network 110. For example, the label module 112 may be configured to send information about the shipping intermediary and/or the shipper to the shipping carrier system 104 and/or the shipping program 102 via the network 110 in order to apply for and obtain an account with the shipping carrier system 104 and/or the shipping program 102. As another example, the label module 112 may be configured to send information, via the network 110, to the shipping carrier system and/or the shipping program 102 relating to registration for the shipping program 102, establishment of a postage payment account held by the shipping intermediary, and/or request of a shipping intermediary identifier, such as, for example, a master MID and/or a MID. The shipping intermediary identifier may be used by the shipping carrier system to provide the shipping services for packages that bear the shipping intermediary identifier. As a further example, the label module 112 may also be configured to request one or more shipping labels from the shipping carrier system and/or the shipping program 102 via the network 110. As yet another example, the label module 112 may be configured to provide to the shipping carrier system and/or the shipping program 102, via the network 110, one or more payments, using the postage payment account, for one or more postage amounts associated with the shipping labels. As still another example, the label module 112 may be further configured to receive the shipping intermediary identifier from the shipping carrier system. As a further example, the label module 112 may be configured to receive the shipping labels from the shipping carrier system 104 and/or the shipping program 102 via the network 110. Additionally, the label module 112 may be configured to receive, via the network 110, a notification or indication from the shipping carrier system 104 and/or the shipping program 102 that a particular payment or a group of payments provided by the label module 112 correspond to an underpayment.

The shipper device 116 may include a hardware device such as a tablet computer, a laptop computer, a desktop computer, a smartphone, a personal digital assistant (PDA), or other hardware device that includes a processor, a memory, and network communication capabilities. In some implementations, the shipper device 116 may be communicatively coupled to the network 110. In some implementations, the shipper module 114 may be configured to send and receive data to and from the label module 112 via the network 110. For example, the shipper module 114 may be configured to send to the label module 112, via the network 110, the shipper's volume of periodic shipping activities, which may correspond to an approximate number of packages and/or a weight of packages shipped by the shipper during a duration of time. The shipper's volume of periodic shipping activities may be input by the shipper using the shipper device 116. As another example, the shipper module 114 may be configured to send to the label module 112, via the network 110, information about the shipper that may aid the label module 112 in generation of a shipping label, such as, for example, a mailing site address to which a package will be shipped. As a further example, the shipper module 114 may be configured to send to the label module 112, via the network 110, information about the shipper that may aid the label module 112 in obtaining an account or a mailer identification from the shipping carrier system 104 and/or the shipping program 102. As yet another example, the shipper module 114 may also be configured to send to the label module 112, via the network 110, information related to the shipper's payment account, which the label module 112 may charge in response to a request from the shipper for one or more shipping labels. In some implementations, the shipper module 114 may be configured to receive the shipping labels from the label module 112. In these and other implementations, the label module 112 may be configured to transmit to the shipper information configured to facilitate obtaining of the shipping labels by the shipper. For example, the information may include one or more questions related to mailing site address, a return address, and/or a postage amount. The label module 112 may receive one or more responses to the information from the shipper and may request a particular shipping label from the shipping carrier system based on information from the responses.

In some implementations, the printer device 108 may include a standard printer. The printer device 108 may be coupled to the shipper module 114. Additionally or alternatively, the printer device 108 may be communicatively coupled to the label module 112 and/or the shipper module 114 via the network 110. The printer device 108 may receive the shipping labels configured to be printed from the shipping intermediary system 106 or the shipper module 114 and may print the shipping labels. The shipper may apply the shipping labels to the shipper's packages.

The shipping carrier system 104 may include a hardware device such as a rack-mounted server, a blade server, or other hardware device that includes a processor, a memory, and network communication capabilities. In some implementations, the shipping carrier system 104, which may include, for example, a shipping carrier system of the USPS, may be communicatively coupled to the network 110. In some implementations, the shipping program 102 may include eVS or another application of the USPS or of another shipping carrier. In some implementations, the shipping program 102 may be configured to send and receive data to and from the label module 112 via the network 110. For example, the shipping program 102 may be configured to generate and send the shipping labels to the label module 112. In these and other implementations, the shipping program 102 may be configured to generate the shipping labels in a final form ready for printing. The shipping label in the final form ready for printing may include all information for shipment. For example, the shipping label in the final form may include one or more of the following: the mailing site address, a return address, postage, and Delivery Confirmation or Express Mail barcodes (in case of the USPS shipping carrier system). As another example, the shipping program 102 may be configured to send one or more shipping intermediary identifiers and/or customer identifiers to the shipping intermediary system 106. In some implementations, the shipping intermediary system 106 may store a cache of the shipping intermediary identifiers and/or the customer identifiers at the shipping intermediary system 106 and may retrieve a particular one of the mailer identifications from the cache in response to receiving a request for a particular shipping label from the shipper.

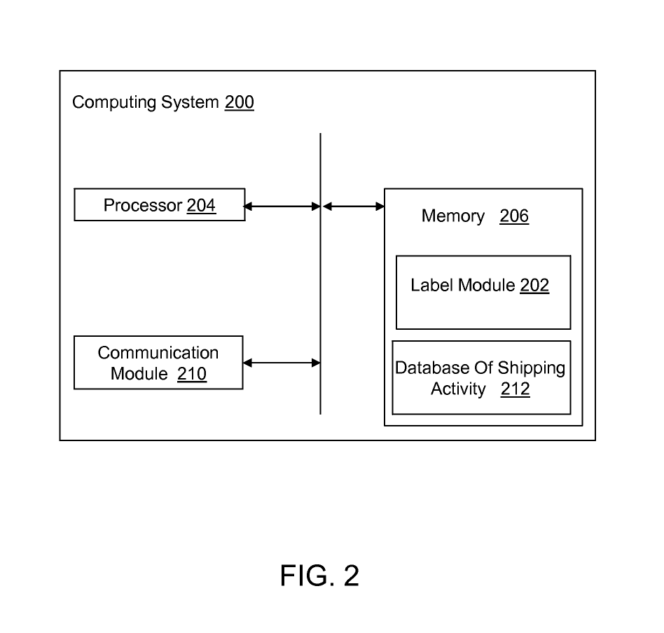

FIG. 2 illustrates an example computing system 200 that may include a label module 202, arranged in accordance with at least one implementation described in the present disclosure. The label module 202 may include or correspond to the label module 112 of FIG. 1. The computing system 200 may include or correspond to the shipping intermediary system 106 of FIG. 1. The computing system 200 may include a processor 204, a memory 206, and a communication module 210.

More generally, the computing system 200 may include any suitable system, apparatus, or device configured to provide the shipping services to shippers. In some implementations, the computing system 200 may provide one or more payments on behalf of the shipper to the shipping carrier system and/or send shipping labels to the shipper. The processor 204 may be communicatively coupled to the memory 206. In some implementations, the label module 202 may be embodied in logic or instructions resident in the memory 206 for execution by the processor 204. Additionally or alternatively, the memory may store shipper data in a database of shipping activity 212. The database of shipping activity 212 may be used to associate one or more particular shipping labels with a particular shipper. Specifically, the database of shipping activity 212 may be configured to facilitate determination by the label module 202 that a particular shipping label is associated with the particular shipper. In some implementations, the database of shipping activity 212 may be configured to facilitate determination by the label module 202 of which barcode, account number, customer identifier, and/or other identifier the label module 202 has assigned to the particular shipper. For example, the shipper data may include a name of the particular shipper and a particular barcode, a particular account number, a particular customer identifier, and/or a particular other identifier associated with a particular shipping label intended for a package of the particular shipper. The name of the particular shipper may be associated with the particular barcode, the particular account number, the particular customer identifier, and/or the particular other identifier in the database of shipping activity. Further, the database of shipping activity 212 may include the shipping activity of the particular shipper. In some these and other implementations, in response to the particular shipper having less than a threshold volume of periodic shipping activities, the shipping activity of the particular shipper may be tracked using the particular account number assigned to the particular shipper. In response to the particular shipper having more than the threshold volume of periodic shipping activities, the shipping activity of the particular shipper may be tracked using, for example, a customer identifier assigned to the particular. The shipping activity of the particular shipper, which may be stored in the database of shipping activity 212, may include information obtained from tracking the particular shipper, such as, for example, a location of a package of the particular shipper and/or a time of arrival of the package at a destination or mailing site address to which the package is intended to be shipped.

The processor 204 may include any suitable special-purpose or general-purpose computer, computing entity, or processing device including various computer hardware or software modules and may be configured to execute instructions stored on any applicable computer-readable storage media to perform or control performance of one or more of the operations described herein. For example, the processor 204 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 2, it is understood that the processor 204 may include any number of processors configured to perform individually or collectively any number of operations described herein. Additionally, one or more of the processors may be present on one or more different electronic devices, servers, or systems. In some implementations, the processor 204 may interpret and/or execute program instructions and/or process data stored in the memory 206.

The memory 206 may include computer-readable storage media for carrying or having computer-executable instructions or data structures stored thereon. Such computer-readable storage media may be any available media that may be accessed by a general-purpose or special-purpose computer, such as the processor 204. By way of example, and not limitation, such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 204 to perform or control performance of a certain function (or operation) or group of functions (or operations).

The label module 202 may include instructions and data configured to cause the processor 204 to perform or control performance of one or more operations described in the present disclosure. For example, the label module 202 may include instructions and data configured to cause the processor 204 to provide the shipping services to shippers and/or coordinate one or more payments of the shipper to the shipping carrier system. Accordingly, in some implementations, the computing system 200 may incorporate the label module 202 in the memory 206 as illustrated in FIG. 2.

The communication module 210 may include software including routines for handling communications between the label module 202 and other components of the computing system 200. Additionally or alternatively, the communication module 210 may be configured to send and receive data to and from one or more other entities via a network. In these and other implementations, the communication module 210 may include hardware such as a cellular transceiver, a WiFi (or more generally, an IEEE 802.11) interface, a Bluetooth wireless interface, a USB interface, a hardwired LAN interface, or other suitable hardware to access the network. In some implementations, the network may include or correspond to the network 110 of FIG. 1. In these or other implementations, the communication module 210 may be configured to retrieve data from the memory 206 and to send the data to the label module 202. For example, the communication module 210 may receive shipper data and/or data related to shipping activity from the shipper and store the data in the database of shipping activity 212 in the memory 206.

One or more operations described in the present disclosure that may be performed by the processor 204 by executing program instructions included in the label module 202 may be performed by a mobile application or a thin-client application on a shipper device. In some implementations, the shipper device may include or correspond to the shipper device 116 of FIG. 1. In some implementations, the shipping intermediary system may include a remote interface that may be used by the shipper or shipper device to communicate with the shipping intermediary system. In these and other implementations, the label module 202 of FIG. 2 may provide and support the remote interface to the shipper on the shipper device via a browser. In these and other implementations, the shipper device may perform one or more of the operations described in the present disclosure by interfacing with the browser. Further, in some implementations, the processor 204 may perform one or more of the operations described in the present disclosure by interfacing with the API of the shipping program.

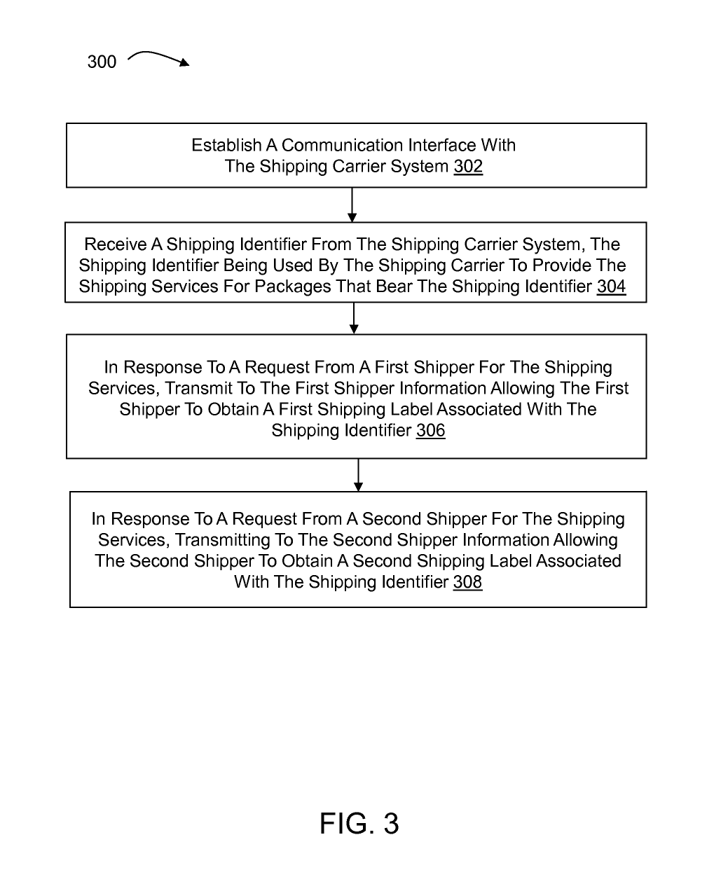

FIG. 3 is a flow diagram of an example method 300 to provide shipping services to shippers, by which packages associated with the shippers are shipped by a shipping carrier, arranged in accordance with at least one implementation described in the present disclosure. One or more operations associated with the method 300 may be implemented, in some implementations, by the shipping intermediary system 106 of FIG. 1 and/or the computing system 200 of FIG. 2. For example, the processor 204 of FIG. 2 may be configured to perform one or more of the operations associated with the method 300 by executing program instructions of the label module 202. Although illustrated as discrete blocks, various blocks may be divided into additional blocks, combined into fewer blocks, or eliminated, depending on the desired implementation.

The method 300 may begin at block 302, where a communication interface with the shipping carrier system may be established. The shipping carrier system may include or correspond to the shipping carrier system 104 of FIG. 1. In some implementations, the communication interface may be established by implementing an application program interface (API) provided by the shipping program, such as, for example, the USPS eVS Label API, via a network. A shipper device may include a shipper module which may execute in a browser and may be communicatively coupled to the label module via the network. Block 302 may be followed by block 304.

At block 304, a shipping intermediary identifier may be received from the shipping carrier system. The shipping intermediary identifier may be used by the shipping carrier system to provide shipping services for packages that bear the shipping intermediary identifier. In these and other implementations, the shipping services may be provided by the shipping carrier system through the shipping program. The shipping program may permit shippers to establish said communication interface and to obtain shipping labels directly from the shipping carrier system only if the shippers have more than a threshold volume of periodic shipping activities. The shipping intermediary identifier may be associated by the shipping carrier system with the shipping intermediary. In these and other implementations, the shipping intermediary identifier may include an eVS master Mailer Identification number, which may be registered to the shipping intermediary. In some implementations, a barcode printed on a shipping label for a package of the first shipper may include the shipping intermediary identifier. In these and other implementations, the shipping intermediary identifier may be configured to facilitate identification of the shipping intermediary by the shipping carrier system. Block 304 may be followed by block 306.

At block 306, in response to a request from a first shipper for the shipping services, information allowing the first shipper to obtain a first shipping label associated with the shipping intermediary identifier may be transmitted to the first shipper. In these and other implementations, the first shipper may have less than the threshold volume of periodic shipping activities. In these and other implementations, the request from the first shipper may be received via a network. The network may include or correspond to the network 110 of FIG. 1. In these and other implementations, the request from the first shipper may be generated by the shipper module 114 of FIG. 1 in response to input of the request from the first shipper by the first shipper. In these and other implementations, the request from the first shipper may be sent to and received by the label module 112 of FIG. 1. Block 306 may be followed by block 308.

At block 308, in response to a request from a second shipper for shipping services, information allowing the second shipper to obtain a second shipping label associated with the shipping intermediary identifier may be transmitted to the second shipper. In these and other implementations, the second shipper may have less than the threshold volume of periodic shipping activities. In these and other implementations, the request from the second shipper may be received via the network. In these and other implementations, the request from the second shipper may be sent to and received by the label module 112 of FIG. 1. In these and other implementations, the request from the second shipper may be generated by the shipper module 114 of FIG. 1 in response to input of the request from the second shipper by the second shipper. In some implementations, each of the first and second shippers may have access to different shipper devices 116 that have different shipper modules 114 (or different instances of the shipper module 114) such that the request from the first shipper may be generated by the shipper module 114 on a first shipper device 116 associated with the first shipper and the request from the second shipper may be generated by the shipper module 114 on a second shipper device 116 associated with the second shipper.

In these and other implementations, the method 300 may enable the first shipper to obtain the first shipping label and the second shipper to obtain the second shipping label from the shipping program through the shipping intermediary system. For example, the shipping program may be configured to generate the first and second shipping labels and send the shipping labels to the shipping intermediary system. The first and second shippers may then obtain the first and second shipping labels, respectively, from the shipping intermediary system. In these and other implementations, the shipping program may generate the first and second shipping labels in a final form ready for printing and intended for placement on packages of the first and second shippers, respectively.

The method 300 may be performed such that, when the first shipper and the second shipper use the shipping services, the shipping carrier system does not distinguish identities of the first shipper and the second shipper. In these and other implementations, the shipping intermediary identifier may be configured to facilitate identification of the shipping intermediary by the shipping carrier system, but the identity of the first and second shippers may be masked to the shipping carrier system. In these and other implementations, the shipping carrier system may associate the first and second shipping labels with the shipping intermediary and not the first and second shippers, respectively. In these and other implementations, the shipping carrier system may identify the shipping intermediary from the first and second shipping labels and not the first and second shippers, respectively. In these and other implementations, the shipping carrier system may determine the identity of the first and second shippers by contacting the shipping intermediary. In some implementations, communications from the USPS, which may include communications regarding the first shipping label and/or a postage payment associated with the first shipping label, may be addressed to the shipping intermediary. Similarly, communications regarding the second shipping label and/or a postage payment associated with the second shipping label may be addressed to the shipping intermediary. In some implementations, the first and second shipping labels may lack customer identifiers, which may be explained later in additional detail.

In some implementations, the method 300 may include in response to a request from a third shipper for the shipping services, transmitting to the third shipper information allowing the third shipper to obtain a third shipping label associated with the shipping intermediary identifier. Thus, in these and other implementations, the first, second, and third shippers may obtain the first, second, and third shipping labels, respectively, that are each associated with the same shipping intermediary identifier, which may allow the shipping carrier system to identify the shipping intermediary. The third shipper may have at least the threshold volume of periodic shipping activities. In some implementations, the third shipping label may not be associated with the shipping intermediary identifier and the shipping carrier system may communicate with the third shipper directly via a customer identifier.

In these and other implementations, the method 300 may include assigning the third shipper the customer identifier that allows the shipping carrier system to identify the third shipper when the third shipper uses the shipping services. The customer identifier may be associated with the third shipper by the shipping carrier system. For example, the customer identifier may include an eVS master MID, an eVS MID, or another customer identifier that identifies the third shipper to the shipping carrier system. In these and other implementations, the eVS master MID and/or eVS MID may be registered to the third shipper. In some implementations, a barcode printed on a shipping label for a package of the third shipper may include the customer identifier. In these and other implementations, the customer identifier may be configured to facilitate identification of the third shipper by the shipping carrier system. In these and other implementations, the shipping carrier system may associate the third shipping label with the third shipper. In these and other implementations, the shipping carrier system may determine the identity of the third shipper using the customer identifier.

In some implementations, the method 300 may include determining one or more of the following: a first volume of periodic shipping activities of the first shipper, a second volume of periodic shipping activities of the second shipper, and a third volume of periodic shipping activities of the third shipper. In some implementations, a particular volume of periodic shipping activities may be determined by the shipping intermediary system. The particular volume of periodic shipping activities may be determined based on input of the particular volume of periodic shipping by a particular shipper at the particular shipper's shipper device.

In these and other implementations, the method 300 may include assigning the first shipper and/or the second shipper to a first group based on the first volume of periodic shipping activities and the second volume of periodic shipping activities, respectively. In some implementations, the first volume of periodic shipping activities and/or the second volume of periodic shipping activities may be less than the third volume of periodic shipping activities. Alternatively or additionally, any shipper that has a volume of periodic shipping activities less than the threshold volume of periodic shipping activities may be assigned to the first group, where the first volume of periodic shipping activities and/or the second volume of periodic shipping activities in this example may be less than the threshold volume of periodic shipping activities.

In these and other implementations, the third shipper may be assigned to a second group based on the third volume of periodic shipping activities. The third volume of periodic shipping activities may be less than the second volume of periodic shipping activities. In these and other implementations, the first group may include one or more shippers in addition to the first shipper and/or the second shipper that ship low volumes of packages compared to the third shipper and one or more other shippers in the second group. The third shipper and the other shippers in the second group may ship high volumes of packages compared to the first shipper, the second shipper, and/or the shippers in the first group. In some implementations, the first group may include low-volume shippers, and the second group may include high-volume shippers. Alternatively or additionally, each shipper assigned to the second group may be assigned a shipper-specific customer identifier, each of which may be individually registered to a corresponding one of the shippers in the second group. The method 300 may further include in response to assignment of the third shipper to the second group, sending the third shipping label to the third shipper. The third shipping label may be associated by the shipping carrier system with the shipping intermediary and/or the third shipper.

In these and other implementations, in response to assignment of the first shipper to the first group, the first shipping label may be sent to the first shipper. The first shipping label may be associated with a shipping intermediary identifier associated by a shipping carrier system with the shipping intermediary. Alternatively or additionally, the shipping intermediary identifier associated by the shipping carrier system with the shipping intermediary may effectively be shared among multiple low-volume shippers. Thus, in some implementations, the multiple low-volume shippers may each be sent a particular shipping label that is associated with a single shipping intermediary identifier associated by the shipping carrier system with the shipping intermediary.

In some implementations, the method 300 may also include providing a first payment for a first postage amount associated with the first shipping label and a second payment for a second postage amount associated with the second shipping label to the shipping carrier system from one or more shipping carrier system accounts held by the shipping intermediary. The method may also include providing a third payment for a third postage amount associated with the third shipping label from the one or more shipping carrier system accounts held by the shipping intermediary. For example, the shipping carrier system accounts may include an eVS account. For example, the shipping carrier system accounts may include a USPS PostalOne! postage payment account or a Centralized Account Processing System (CAPS) account. The shipping intermediary may thus coordinate payments of the first shipper, the second shipper, and/or the third shipper to the shipping carrier system using the shipping carrier system accounts and without use of a postage meter. In some implementations, the shipping carrier system accounts may include a payment account from which funds may be transferred to the shipping carrier system. In these and other implementations, the method 300 may include providing one or more of the following from a single shipping carrier system account held by the shipping intermediary: the first payment for the first postage amount associated with the first shipping label, the second payment for the second postage amount associated with the second shipping label, and the third payment for a third postage amount associated with the third shipping label.

In some implementations, the method 300 may also include receiving one or more of the following generated by the shipping carrier system and configured to be printed: the first shipping label, the second shipping label, and the third shipping label. In these and other implementations, the method 300 may include one or more of the following: sending the first shipping label to the first shipper, sending the second shipping label to the second shipper, and sending the third shipping label to the third shipper. The first, second, and third shippers may obtain the first, second, and third shipping labels, respectively, in response to the labels being sent.

In some implementations, the method 300 may also include assigning a first account number to the first shipper and assigning a second account number to the second shipper. The first account number and the second account number may be used by the shipping intermediary system to track shipping activity of the first shipper and the second shipper, respectively, but may not be provided to the shipping carrier. In these and other implementations, the method 300 may also include assigning a third account number to the third shipper, which may be used by the shipping intermediary system to track shipping activity of the third shipper and may not be provided to the shipping carrier.

In some implementations, the method 300 may also include maintaining a database of shipping activity of the first shipper and the second shipper. The method 300 may include associating the first shipping label with the first shipper in the database and associating the second shipping label with the second shipper in the database. In these and other implementations, the database may be configured to facilitate tracking of the first shipper and the second shipper by the shipping intermediary via the first account number and the second account number assigned to the first and second shippers, respectively. For example, the first account number and the second account number may be recorded and stored in the database as corresponding to the first and second shippers, respectively, and one or more shipping activities may be associated with the first and second account numbers in the database.

In these and other implementations, in response to receipt of an indication from the shipping carrier system that a payment by the server of a first postage amount associated with the first shipping label corresponds to an underpayment, the method 300 may include determining using the database that the first shipper is associated with the first shipping label and the underpayment and charging the first shipper an amount corresponding to the underpayment. The second and third shippers may not be charged for an amount corresponding to the underpayment.

Shipping activity of the third shipper may be stored in the database of shipping activity in a similar manner as the shipping activity of the first shipper and the shipping activity of the second shipper.

In some implementations, the shipping intermediary system may include remote interfaces used by the first and second shippers to communicate with the intermediary. For example, a first remote interface and a second remote interface may be used by the first shipper device and the second shipper device, respectively, to communicate with the shipping intermediary system. The remote interfaces may be provided to the first and second shippers on their respective shipper devices via a browser.

In some implementations, the method 300 may include submitting an electronic manifest for the third shipper in response to assignment of the third shipper to the second group. The electronic manifest may be submitted to the shipping program. In some implementations, the shipping program may be configured to facilitate monitoring of receipt of the electronic manifest by the third shipper and/or to facilitate analyzing, by the third shipper, of results of package sampling performed by the shipping carrier. In some implementations, the electronic manifest may include the customer identifier and/or the shipping intermediary identifier. The electronic manifest may also include a detailed summary of one or more packages shipped at one time by the third shipper, including postage amounts paid by the shipping intermediary for each of the shipping labels associated with the packages. In some implementations, one or more electronic manifests may be submitted for shippers in the second group. In these and other implementations, the electronic manifests may not be submitted for shippers in the first group.

For this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed implementations.

While some of the systems and methods described herein are generally described as being implemented in software (stored on and/or executed by general purpose hardware), specific hardware implementations or a combination of software and specific hardware implementations are also possible and contemplated.

Terms used herein and in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited herein are intended for pedagogical objects to aid the reader in understanding the invention and the concepts contributed by the inventor to furthering the art, and are to be construed as being without limitation to such specifically recited examples and conditions. Although implementations of the present disclosure have been described in detail, it should be understood that the various changes, substitutions, and alterations could be made hereto without departing from the spirit and scope of the present disclosure.

1. A method for providing shipping services to shippers, by which packages associated with the shippers are shipped by a shipping carrier, the method being performed by a system associated with a shipping intermediary, the method comprising:
providing software to interface with a shipping program through which the shipping services are available, wherein the software satisfies specifications of the shipping program for producing manifests and barcodes;
executing the software to establish a communication interface with the shipping carrier;
receiving a shipping intermediary identifier from the shipping carrier, the shipping intermediary identifier being used by the shipping carrier to provide the shipping services for packages that bear the shipping intermediary identifier, the shipping intermediary identifier being associated by the shipping carrier with the shipping intermediary and identifying the shipping intermediary to the shipping carrier as an entity that satisfies requirements imposed by the shipping carrier to qualify for the shipping services;
in response to a request from a first shipper for the shipping services:
transmitting to the shipping program a request on behalf of the first shipper for a first shipping label;
receiving the first shipping label from the shipping program; and
sending the first shipping label to the first shipper, wherein the first shipping label is associated with and includes the shipping intermediary identifier; and
in response to a request from a second shipper for the shipping services:
transmitting to the shipping program a request on behalf of the second shipper for a second shipping label.
receiving the second shipping label from the shipping program; and
sending the second shipping label to the second shipper, wherein the second shipping label is associated with and includes the shipping intermediary identifier such that, when the first shipper and the second shipper use the shipping services, the shipping carrier does not distinguish the identities of the first shipper and the second shipper,
wherein the first and second shipping labels in an electronic form are printed and the printed first and second shipping labels are respectively applied to a first package to be shipped by the first shipper and a second package to be shipped by the second shipper, the shipping carrier providing the shipping services for the first and second packages that bear the shipping intermediary identifier in each of the printed first and second shipping labels, and
wherein the shipping services provided by the shipping carrier are available to the first and second shippers through aggregation of the first and second shippers by the shipping intermediary, the first and second shippers individually failing to satisfy the requirements imposed by the shipping carrier to qualify for the shipping services.

2. The method of claim 1, wherein the shipping program permits shippers that individually satisfy requirements imposed by the shipping carrier to qualify for the shipping services to establish said communication interface and to obtain shipping labels directly from the shipping carrier.

3. The method of claim 2, wherein the shipping program comprises a manifest system in which shippers document and pay postage by transmitting electronic manifest files to the manifest system.

4. The method of claim 2, wherein:
each of the first shipper and the second shipper individually has less than a threshold volume of periodic shipping activities below which the first shipper and the second shipper is each unable to obtain shipping labels from the shipping program without the shipping intermediary; and
the method further comprises enabling the first shipper to obtain the first shipping label and enabling the second shipper to obtain the second shipping label from the shipping program through the shipping intermediary.

5. The method of claim 1, further comprising:
assigning a first account number to the first shipper; and
assigning a second account number to the second shipper,
wherein the first account number and the second account number are used by the shipping intermediary to track shipping activity of the first shipper and the second shipper, respectively, but are not provided to the shipping carrier.

6. The method of claim 5, further comprising maintaining a database of shipping activity of the first shipper and the second shipper.

7. The method of claim 1, wherein the system associated with the shipping intermediary comprises remote interfaces used by the first shipper and the second shipper to communicate with the shipping intermediary.

8. The method of claim 1, further comprising:
in response to a request from a third shipper for the shipping services, transmitting to the third shipper information allowing the third shipper to obtain a third shipping label associated with the shipping intermediary identifier; and
assigning the third shipper a customer identifier that allows the shipping carrier to identify the third shipper when the third shipper uses the shipping services.

9. The method of claim 8, wherein:
the shipping program permits shippers to establish said communication interface and to obtain shipping labels directly from the shipping carrier only if the shippers have more than a threshold volume of periodic shipping activities;
the first shipper and the second shipper have less than the threshold volume of periodic shipping activities; and
the third shipper has at least the threshold volume of periodic shipping activities.

10. A non-transitory computer-readable storage media including computer-executable instructions executable by a processor of a system associated with a shipping intermediary to perform or control performance of operations for providing shipping services to shippers, by which packages associated with the shippers are shipper by a shipping carrier, the operations comprising:
providing software to interface with a shipping program through which the shipping services are available, wherein the software satisfies specifications of the shipping program for producing manifests and barcodes;
executing the software to establish a communication interface with the shipping carrier;
receiving a shipping intermediary identifier from the shipping carrier, the shipping intermediary identifier being used by the shipping carrier to provide the shipping services for packages that bear the shipping intermediary identifier, the shipping intermediary identifier being associated by the shipping carrier with the shipping intermediary and identifying the shipping intermediary to the shipping carrier as an entity that satisfies requirements imposed by the shipping carrier to qualify for the shipping services;
in response to a request from a first shipper for the shipping services:
transmitting to the shipping program a request on behalf of the first shipper for a first shipping label
receiving the first shipping label from the shipping program; and
sending the first shipping label to the first shipper, wherein the first shipping label is associated with and includes the shipping intermediary identifier; and
in response to a request from a second shipper for the shipping services:
transmitting to the shipping program a request on behalf of the second shipper for a second shipping label;
receiving the second shipping label from the shipping program; and
sending the second shipping label to the second shipper, wherein the second shipping label is associated with and includes the shipping intermediary identifier such that, when the first shipper and the second shipper use the shipping services, the shipping carrier does not distinguish the identities of the first shipper and the second shipper,
wherein the first and second shipping labels in an electronic form are printed and the printed first and second shipping labels are respectively applied to a first package to be shipped by the first shipper and a second package to be shipped by the second shipper, the shipping carrier providing the shipping services for the first and second packages that bear the shipping intermediary identifier in each of the printed first and second shipping labels, and
wherein the shipping services provided by the shipping carrier are available to the first and second shippers through aggregation of the first and second shippers by the shipping intermediary, the first and second shippers individually failing to satisfy the requirements imposed by the shipping carrier to qualify for the shipping services.

11. The computer-readable storage media of claim 10, wherein the shipping program permits shippers that individually satisfy requirements imposed by the shipping carrier to qualify for the shipping services to establish said communication interface and to obtain shipping labels directly from the shipping carrier.

12. The computer-readable storage media of claim 11, wherein:
each of the first shipper and the second shipper individually has less than a threshold volume of periodic shipping activities below which the first shipper and the second shipper is each unable to obtain shipping labels from the shipping program without the shipping intermediary; and
the operations further comprise enabling the first shipper to obtain the first shipping label and enabling the second shipper to obtain the second shipping label from the shipping program through the shipping intermediary.

13. The computer-readable storage media of claim 10, wherein the operations further comprise:
assigning a first account number to the first shipper; and
assigning a second account number to the second shipper,
wherein the first account number and the second account number are used by the shipping intermediary to track shipping activity of the first shipper and the second shipper, respectively, but are not provided to the shipping carrier.

14. The computer-readable storage media of claim 10, wherein the operations further comprise:
in response to a request from a third shipper for the shipping services, transmitting to the third shipper information allowing the third shipper to obtain a third shipping label associated with the shipping intermediary identifier; and
assigning the third shipper a customer identifier that allows the shipping carrier to identify the third shipper when the third shipper uses the shipping services.

15. The computer-readable storage media of claim 14, wherein:
the shipping program permits shippers to establish said communication interface and to obtain shipping labels directly from the shipping carrier only if the shippers have more than a threshold volume of periodic shipping activities;
the first shipper and the second shipper have less than the threshold volume of periodic shipping activities; and
the third shipper has at least the threshold volume of periodic shipping activities.

16. A system for providing shipping services to shippers, by which packages associated with the shippers are shipped by a shipping carrier, the system being associated with a shipping intermediary and comprising a processor configured to:
provide software to interface with a shipping program through which the shipping services are available, wherein the software satisfies specifications of the shipping program for producing manifests and barcodes;
execute the software to establish a communication interface with the shipping carrier;
receive a shipping intermediary identifier from the shipping carrier, the shipping intermediary identifier being used by the shipping carrier to provide the shipping services for packages that bear the shipping intermediary identifier, the shipping intermediary identifier being associated by the shipping carrier with the shipping intermediary and identifying the shipping intermediary to the shipping carrier as an entity that satisfies requirements imposed by the shipping carrier to qualify for the shipping services;
in response to a request from a first shipper for the shipping services:
transmit to the shipping program a request on behalf of the first shipper for a first shipping label;
receive the first shipping label from the shipping program; and
send the first shipping label to the first shipper, wherein the first shipping label is associated with and includes the shipping intermediary identifier; and
in response to a request from a second shipper for the shipping services:
transmit to the shipping program a request on behalf of the second shipper for a second shipping label; l
receive the second shipping label from the shipping program; and
send the second shipping label to the second shipper, wherein the second shipping label is associated with and includes the shipping intermediary identifier such that, when the first shipper and the second shipper use the shipping services, the shipping carrier does not distinguish the identities of the first shipper and the second shipper,
wherein the first and second shipping labels in an electronic form are printed and the printed first and second shipping labels are respectively applied to a first package to be shipped by the first shipper and a second package to be shipped by the second shipper, the shipping carrier providing the shipping services for the first and second packages that bear the shipping intermediary identifier in each of the printed first and second shipping labels, and
wherein the shipping services provided by the shipping carrier are available to the first and second shippers through aggregation of the first and second shippers by the shipping intermediary, the first and second shippers individually failing to satisfy the requirements imposed by the shipping carrier to qualify for the shipping services.

17. The system of claim 16, wherein the shipping program permits shippers that individually satisfy requirements imposed by the shipping carrier to qualify for the shipping services to establish said communication interface and to obtain shipping labels directly from the shipping carrier, wherein the shipping program comprises a manifest system in which shippers document and pay postage by transmitting electronic manifest files to the manifest system.

18. The system of claim 17, wherein:
each of the first shipper and the second shipper individually has less than a threshold volume of periodic shipping activities below which the first shipper and the second shipper is each unable to obtain shipping labels from the shipping program without the shipping intermediary; and
wherein the processor is further configured to enable the first shipper to obtain the first shipping label and enable the second shipper to obtain the second shipping label from the shipping program through the shipping intermediary.

19. The system of claim 16, wherein the processor is further configured to:
in response to a request from a third shipper for the shipping services, transmit to the third shipper information allowing the third shipper to obtain a third shipping label associated with the shipping intermediary identifier; and
assign the third shipper a customer identifier that allows the shipping carrier to identify the third shipper when the third shipper uses the shipping services.

20. The system of claim 19, wherein:
the shipping program permits shippers to establish said communication interface and to obtain shipping labels directly from the shipping carrier only if the shippers have more than a threshold volume of periodic shipping activities;
the first shipper and the second shipper have less than the threshold volume of periodic shipping activities; and
the third shipper has at least the threshold volume of periodic shipping activities.
